(19) United States
(12) Patent Application Publication
(10) Pub. No.: US 2011/0236080 A1
(43) Pub. Date: Sep. 29, 2011

(54) INTERMEDIATE TRANSFER MEMBER AND IMAGE-FORMING APPARATUS

(75) Inventor: Ryouji Kouno, Okazaki-shi (JP)

(73) Assignee: Konica Minolta Business Technologies, Inc., Chiyoda-ku (JP)

(21) Appl. No.: 13/046,006

(22) Filed: Mar. 11, 2011

(30) Foreign Application Priority Data
Mar. 23, 2010 (JP) 2010-66300

(51) Int. Cl. G03G 15/01

(52) U.S. Cl. 399/302

(57) ABSTRACT

An intermediate transfer member has an elastic layer and a surface layer formed on the elastic layer, said intermediate transfer member exhibiting 25 to 75% of Er/Ep ratio (wherein Ep is a product of a pushing displacement (μm) and a testing force (mN) at the time of compressing the surface layer by means of an indenter, and Er is a product of a pushing displacement (μm) and a testing force (mN) at the time of releasing the indenter from the surface layer). An image-forming apparatus includes an intermediate transfer member; an image-forming unit for forming a toner image on the intermediate transfer member; and an transferring unit for transferring the toner image formed on the intermediate transfer member onto a recording material, wherein the intermediate transfer member is the same as the one mentioned above.

This application is based on application No. 2010-66300 filed in Japan, the contents of which are hereby incorporated by reference.

### BACKGROUND OF THE INVENTION

1. Field of the Invention

The present invention relates to an intermediate transfer member that is used for primarily transferring a toner image formed on a surface of a photosensitive member in an image-forming apparatus by use of an electrophotographic method, such as a copying machine, a facsimile and a laser printer, and to an image-forming apparatus provided with such an intermediate transfer member.

2. Description of the Related Art

In recent years, in an image-forming apparatus using an electrostatic process, the intermediate transfer belt has been widely used to satisfy demands for high-quality images to be formed on various kinds of paper in various modes. As the intermediate transfer belt, in general, a resin belt typically made from polyimide is widely used because of its high picture-image quality, long service life and highly stable characteristics. However, in the case of the intermediate transfer belt made from a resin, an image loss phenomenon caused by a transferring process due to a change of the toner has been raised as a serious problem. The image loss phenomenon refers to a phenomenon in which, since a great pressure is applied to an image upon transferring the image, the toner is subjected to a stress deformation, with a result that an aggregating force among the toner particles increases to cause one portion of an image to remain on the image supporting member without being transferred, and this phenomenon becomes conspicuous, in particular, in character images, line images and the like. In the case of the resin belt, since a high pressure is given to an image upon transferring the image, this image-loss problem becomes particularly conspicuous.

In order to prevent this image-loss problem, in recent years, an elastic intermediate transfer belt in which an elastic layer is used has been mainly used. Since the elastic intermediate transfer belt has the elastic layer, it is very soft. Therefore, since the pressure to be applied to the toner at a transferring unit can be reduced, it has been known that the elastic intermediate transfer belt is effective for preventing the image-loss phenomenon (Japanese Patent-Application Laid-Open No. 2006-98824 and Japanese Patent-Application Laid-Open No. 2008-209848). Moreover, since the elastic intermediate transfer belt is improved in respect of a contacting property with paper, it has been known that a secondarily-transferring property to regular paper is also improved. Therefore, it has been expected that a transferring property to a special paper (Leathac Paper 99 and the like) having larger concavities and convexities than those in a regular paper is improved, too. However, it has been confirmed by repeating various experiments that all of the intermediate transfer belts having the elastic layer are not improved in respect of the secondarily-transferring property and an intermediate transfer belt having a particular elastic layer is improved in respect of the secondarily-transferring property to the regular paper and the special paper.

### BRIEF SUMMARY OF THE INVENTION

The present invention relates to an intermediate transfer member comprising an elastic layer and a surface layer formed on the elastic layer, said intermediate transfer member exhibiting 25 to 75% of Er/Ep ratio (wherein Ep is a product of a pushing displacement (μm) and a testing force (mN) at the time of compressing the surface layer by means of an indenter, and Er is a product of a pushing displacement (μm) and a testing force (mN) at the time of releasing the indenter from the surface layer).

The present invention also relates to an image-forming apparatus, comprising:

an intermediate transfer member comprising an elastic layer and a surface layer formed on the elastic layer, said intermediate transfer member exhibiting 25 to 75% of Er/Ep ratio (wherein Ep is a product of a pushing displacement (μm) and a testing force (mN) at the time of compressing the surface layer by means of an indenter, and Er is a product of a pushing displacement (μm) and a testing force (mN) at the time of releasing the indenter from the surface layer);

an image-forming unit for forming a toner image on the intermediate transfer member; and

an transferring unit for transferring the toner image formed on the intermediate transfer member onto a recording material.

### BRIEF DESCRIPTION OF THE DRAWINGS

FIG. 1(A) is a schematic cross-sectional view showing one example of the intermediate transfer member according to the present invention, and FIG. 1(B) is a schematic cross-sectional view showing another example of the intermediate transfer member according to the present invention.

FIG. 2 is a graph showing a relationship between a pushing displacement and a testing force for explaining a compression-release hysteresis specified in the present invention.

FIG. 3 is a schematic structural view showing one example of the image-forming apparatus according to the present invention.

### DETAILED DESCRIPTION OF THE INVENTION

An object of the present invention is to provide an intermediate transfer member that is sufficiently improved in respect of a transferring property to a paper having concavities and convexities without reducing a secondary transfer rate and an image-forming apparatus equipped with said intermediate transfer member.

Intermediate Transfer Member

An intermediate transfer member according to the present invention is preferably used for an image-forming apparatus based upon an electrophotographic system, such as a copying machine, a printer and a facsimile. The intermediate transfer member is a member that primarily transfers a toner image supported on a surface of a photosensitive member onto its surface, supports the transferred toner image, and secondarily transfers the supported toner image onto a surface of a member to be transferred, such as a recording paper. If not otherwise specified, although the intermediate transfer member having a belt shape according to the present invention will be explained, the intermediate transfer member may have a drum shape.

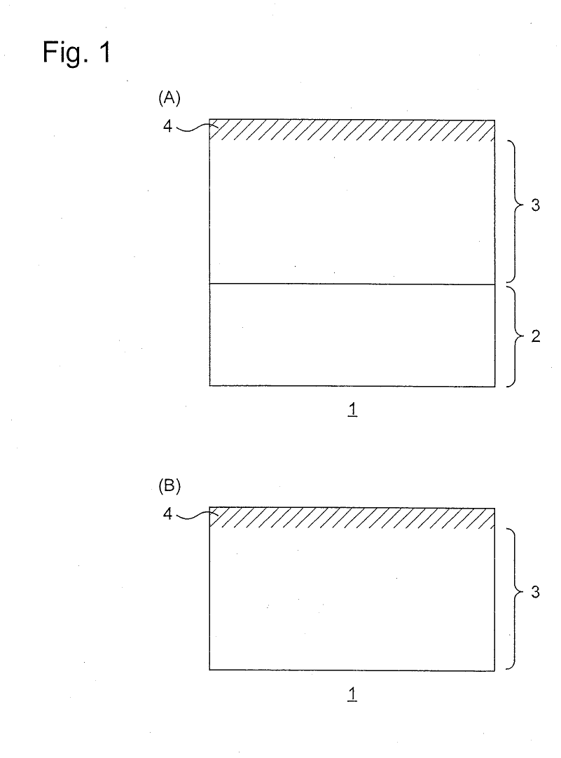

An intermediate transfer belt according to the present invention has the elastic layer and the surface layer formed on the elastic layer, and may have another layer, for example, a so-called base layer. More specifically, an intermediate transfer belt 1 according to the present invention may have a structure in which an elastic layer 3 and an surface layer 4 are successively formed on a base layer 2, as shown in FIG. 1(A), or may have a structure in which the surface layer 4 is formed on the elastic layer 3 without the base layer, as shown in FIG. 1(B). When the intermediate transfer member has a drum shape, the intermediate transfer drum has a structure in which the base layer is formed, as shown in FIG. 1(A) and the base layer 2 has a rigidity for maintaining the drum shape.

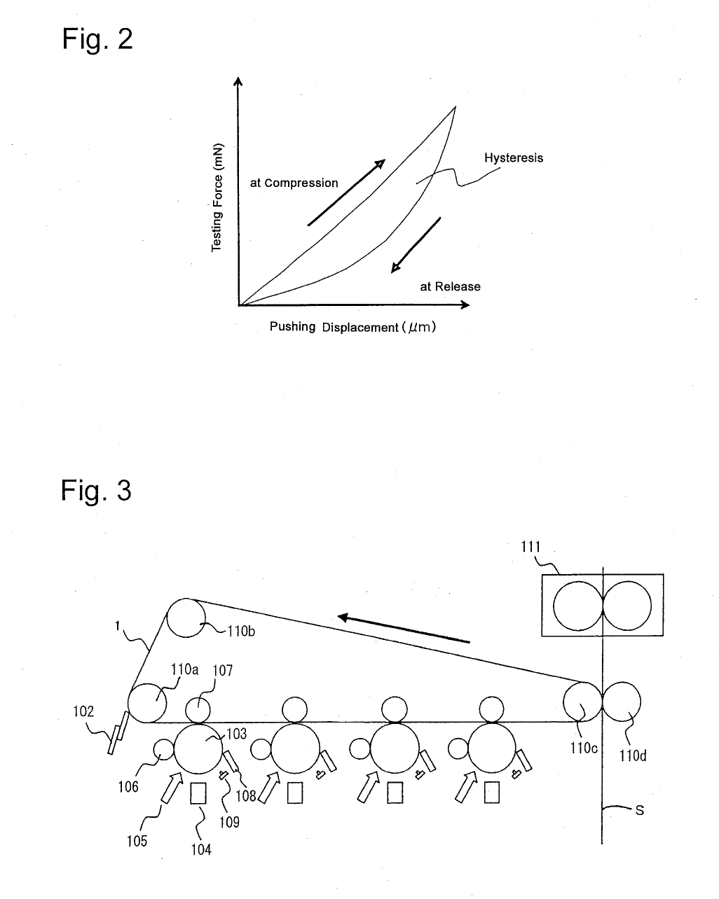

The intermediate transfer belt according to the present invention exhibits a suitably large hysteresis when the indenter is compressed on the surface of the surface layer and released from said surface. The hysteresis means a difference between the product of the pushing displacement and the testing force at the time of compressing the indenter and the product of the pushing displacement and the testing force at the time of releasing the indenter, as shown in a Pushing Displacement-Testing Force graph of FIG. 2. A larger hysteresis means that the compressed surface of the intermediate transfer belt is restored to its original state more slowly. A smaller hysteresis means that the compressed surface of the intermediate transfer belt is restored to its original state more quickly. A surface hardness of the surface layer shows a correlation with a slope at compression in a compression-release hysteresis curve. For example, the surface having a larger hardness shows a hysteresis curve having a larger slope at a compression. For example, the surface having a smaller hardness shows a hysteresis curve having a smaller slope at a compression.

In the present invention, more specifically, the value of Er/Ep ratio is within the range of 25 to 75%, preferably, 40 to 60%, wherein Ep is the product of the pushing displacement (μm) and the testing force (mN) at the time of compressing the surface layer by means of the indenter of a compression microtester (e.g., DUH-W201; manufactured by Simadzu Corporation), and Er is the product of the pushing displacement (μm) and the testing force (mN) at the time of releasing the indenter from the surface layer. The surface of the surface layer is deformed depending on a surface shape of a member to be secondarily transferred, such as a paper, an OHP sheet and the like, during the secondary transfer, and is deformed to a concavo shape by a photosensitive member during the primary transfer. By adjusting the hysteresis within the above mentioned range, the surface of the surface layer is restored to its original state at a suitable velocity after it is deformed. As a result, the surface of the surface layer, which has been deformed depending on the surface shape of the member to be secondarily transferred during the secondary transfer, can maintain said deformation when it passes through a nip for the secondary transfer. Therefore, a sufficient contacting time between the concavities and convexities of the member to be secondarily transferred and the intermediate transfer belt is ensured in order to improve a transferring property to the paper having concavities and convexities. On the other hand, the concavely deformed surface of the surface layer after the primary transfer is sufficiently restored to its original state until the secondary transfer. During the secondary transfer, the surface of the surface layer is convexly deformed by means of rollers around which the intermediate transfer belt is wound, and the contacting area between said deformed surface and the toner is effectively decreased. Therefore, an adhesive force of the toner to the surface of the surface layer is decreased to increase a secondary transfer rate. If the value of Er/Ep is too large, the time from the deformation of the surface of the surface layer to the recovery to its original state becomes too short. Therefore, even if the surface of the surface layer is initially deformed depending on a surface shape of a member to be secondarily transferred during the secondary transfer, a recovery to its original state starts when the surface layer passes through a nip for the secondary transfer. As a result, a space arises between the intermediate transfer belt and the concavities and convexities of the member to be secondarily transferred, and it is impossible to ensure the sufficient contacting time between the intermediate transfer belt and the member to be secondarily transferred. Accordingly, a transferring property to the paper having concavities and convexities is lowered. If the value of Er/Ep is too small, the time from the deformation of the surface of the surface layer to the recovery to its original state becomes too long. Therefore, the concavo deformation, which occurs on the surface of the surface layer during the primary transfer, is not sufficiently recovered until the secondary transfer, and remains. As a result, the contacting area between the surface of the surface layer and the toner is increased. Therefore, an adhesive force of the toner to the surface of the surface layer is increased, and a secondary transfer rate is decreased.

In the present specification, specifically, the values of Ep and Er are used, said values being measured by using the above mentioned compression microtester under the following measuring conditions. As long as it is possible to measure said values under the following conditions, the compression microtester is not restricted to the above mentioned device.

Measuring Conditions

Apex shape of indenter: flat (50 μm diameter)

Falling rate of indenter during compression: 0.142 (mN/sec)

Rising rate of indenter during release: 0.142 (mN/sec)

Maximum testing force: 5.00 (mN)

Minimum testing force: 0.20 (mN)

Surface Layer

The surface layer is not particularly limited as long as its surface shows the above mentioned compression-release hysteresis. Examples of the surface layer include a layer formed by a surface treatment of the elastic layer described below. The surface treatment can be performed by coating an isocyanate compound to a surface of the elastic layer, and then subjecting the coated surface to a heating treatment. That is, the isocyanate compound is coated to an outer circumferential face of the elastic layer and then heated to self-react the isocyanate so that a thin surface layer is formed. Although heating temperature and time for the reaction depend on a coating amount of the isocyanate, the heating temperature may be set in a range from 120 to 200° C., and the heating time may be set in a range from 30 to 120 minutes. When the isocyanate compound is coated to the outer circumferential face of the elastic layer, a method can be adopted, wherein an isocyanate solution is contacted with the surface of the elastic layer to impregnate said solution into said surface. The coating amount can be adjusted by the contact time of the isocyanate solution.

Examples of the isocyanate compound include aromatic isocyanates, aliphatic isocyanates and the like. Specific examples of the isocyanate compound include toluene diisocyanate (TDI), diphenylmethane diisocyanate (MDI), crude MDI and the like. Other compounds may be added to a material for forming the surface layer as long as they do not interfere a reactivity of the isocyanate compound. As a commercially available isocyanate compound, CORONATE HX (made by NIPPON POLYURETHANE INDUSTRY Co, Ltd.), CORONATE L (made by NIPPON POLYURETHANE INDUSTRY Co, Ltd.) and CORONATE 65 (made by NIPPON POLYURETHANE INDUSTRY Co, Ltd.) can be used.

In some cases, a part of the isocyanate compound reacts with the elastic layer. In such a case, the reacted part of the elastic layer is cured and constitutes a part of the surface layer. When the surface layer is formed, the coating amount of the material for forming the surface layer can be set in a range from 1.0×10⁻⁹ to 1.0×10⁻⁴ g/mm².

The value of Er/Ep can be adjusted by adjusting an amount of the isocyanate compound in the material for forming the surface layer and the coating amount of said material to the surface of the elastic layer. The smaller the amount of the isocyanate compound is, the larger the value of Er/Ep becomes. The larger said amount is, the smaller the value of Er/Ep becomes. The smaller the coating amount is, the smaller the value of Er/Ep becomes. The larger the coating amount is, the larger the value of Er/Ep becomes.

In specifically, for example, when CORONATE HX (made by NIPPON POLYURETHANE INDUSTRY Co, Ltd.) is used as the material for the surface treatment and the solution is prepared by adding MEK as a solvent so that a concentration of the isocyanate falls within the range of from 25 to 35 wt %, the surface treatment can be performed, for example, by contacting the solution with the surface of the elastic layer for 10 to 35 seconds to impregnate or coat said solution into or on said surface, and then heating said surface at 150° C. for 60 minutes. For example, when CORONATE HX (made by NIPPON POLYURETHANE INDUSTRY Co, Ltd.) is used as the material for the surface treatment and the solution is prepared by adding MEK as a solvent so that a concentration of the isocyanate falls within the range of from 10 to 25 wt %, the surface treatment can be performed, for example, by contacting the solution with the surface of the elastic layer for 15 to 50 seconds to impregnate or coat said solution into or on said surface, and then heating said surface at 150° C. for 60 minutes. For example, when CORONATE HX (made by NIPPON POLYURETHANE INDUSTRY Co, Ltd.) is used as the material for the surface treatment and the solution is prepared by adding MEK as a solvent so that a concentration of the isocyanate falls within the range of from 35 to 50 wt %, the surface treatment can be performed, for example, by contacting the solution with the surface of the elastic layer for 5 to 25 seconds to impregnate or coat said solution into or on said surface, and then heating said surface at 150° C. for 60 minutes.

For example, when CORONATE L (made by NIPPON POLYURETHANE INDUSTRY Co, Ltd.) is used as the material for the surface treatment and the solution is prepared by adding MEK as a solvent so that a concentration of the isocyanate falls within the range of from 25 to 35 wt %, the surface treatment can be performed, for example, by contacting the solution with the surface of the elastic layer for 12 to 50 seconds to impregnate or coat said solution into or on said surface, and then heating the said surface at 150° C. for 60 minutes.

For example, when CORONATE 65 (made by NIPPON POLYURETHANE INDUSTRY Co, Ltd.) is used as the material for the surface treatment and the solution is prepared by adding MEK as a solvent so that a concentration of the isocyanate falls within the range of from 25 to 35 wt %, the surface treatment can be performed, for example, by contacting the solution with the surface of the elastic layer for 13 to 25 seconds to impregnate or coat said solution into or on said surface, and then heating said surface at 150° C. for 60 minutes.

The surface layer 4 preferably has a surface hardness of from 30° to 65°, more preferably from 40° to 60°.

The surface hardness is a JIS-A hardness which is measured by using a MD-1 hardness tester (made by Asker Co., Ltd.). The surface hardness used in the present specification is an average value of ten measured values at ten arbitrary points of the surface layer.

Although the thickness of the surface layer 4 can not strictly be specified since the surface layer is reacted with a part of the elastic layer, it falls normally within the range of from 0.1 μm to 2.0 μm.

The thickness of the surface layer 4 used in the present specification is obtained by measuring said thickness on a cross-sectional image in a thickness direction taken by means of a scanning electron microscope (SEM).

Although the surface roughness Rz of the surface layer 4 is not particularly restricted as long as the surface of the surface layer shows the above mentioned compression-release hysteresis, the Rz falls preferably within the range of from 0.05 to 1.5 μm, more preferably, from 0.1 to 1.0 μm.

The surface roughness Rz used in the present specification is an average value of ten measured values obtained at ten arbitrary points by a Surfcom 480A (made by Tokyo Seimitsu Co., Ltd.). The surface roughness Rz is not necessarily required to be measured by the above-mentioned device, and any device may be used for the measurements, as long as it can measure based upon the same principle and rule as those of the device.

Elastic Layer/Base Layer

The elastic layer 3 is an organic compound layer having elasticity. As the elastic material forming the elastic layer (elastic material rubbers, elastomers), one kind or two or more kinds of materials selected from the following group may be used. The group consists of butyl rubber, fluorine-based rubber, acryl rubber, EPDM, NBR, acrylonitrile-butadiene-styrene rubber, natural rubber, isoprene rubber, styrene-butadiene rubber, butadiene rubber, ethylene-propylene rubber, ethylene-propylene ter-polymer, chloroprene rubber, chlorosulfonated polyethylene, chlorinated polyethylene, urethane rubber, syndiotactic 1,2-polybutadiene, epichlorohydrin-based rubber, silicone rubber, fluorine rubber, polysulfide rubber, polynorbornane rubber, hydrogenated nitrile rubber, and thermoplastic elastomer (for example, polystyrene-based, polyolefin-based, polyvinyl chloride-based, polyurethane-based, polyamide-based, polyurea-based, polyester-based and fluorine resin-based elastomers). The elastic material which constitutes the elastic layer is preferably NBR. However, needless to say, the present invention is not limited thereto.

A resistance-value adjusting conductive agent may be added to the elastic layer 3. Although not particularly limited, examples of the resistance-value adjusting conductive agent include: carbon black, graphite, metal powder, such as aluminum and nickel, and conductive metal oxides, such as tin oxide, titanium oxide, antimony oxide, indium oxide, potassium titanate, antimony oxide-tin oxide composite oxide (ATO) and indium oxide-tin oxide composite oxide (ITO). The conductive metal oxide may be coated with insulating fine particles, such as barium sulfate, magnesium silicate and calcium carbonate. The present invention is not limited to the above-mentioned conductive agents.

The surface roughness Rz of the elastic layer 3 is set within the same range as that of Rz of the aforesaid surface layer. A change of the surface roughness before and after the surface treatment is small.

Although the thickness of the elastic layer 3 is not particularly limited as long as the objective of the present invention is achieved, said thickness is normally set in the range of from 50 to 1000 μm, preferably, from 50 to 500 μm, more preferably, from 100 to 500 μm.

From the viewpoint of further improvement of the transferring property to concavities and convexities and the transfer rate at the secondary transfer, the hardness of the elastic layer is preferably set in the range of from 10 to 60, more preferably, from 25 to 40.

The hardness of the elastic layer is a hardness of said layer before the surface layer is formed.

The hardness of the elastic layer is an value measured by using the same method as in the case of the surface layer.

The volume resistivity of the elastic layer is preferably set in the range of from 10⁹ to 10¹³Ω·cm, more preferably, from 10⁹ to 10¹⁰Ω·cm.

The volume resistivity is indicated by an average value of measured values in arbitrary ten points obtained by using a Hirester (made by Mitsubishi Chemical Analytech Co., Ltd).

The base layer 2 is an organic polymer compound layer. As the resin material forming the base layer, one kind or two or more kinds of materials selected from the following group may be used. The group consists of polycarbonate, fluorine-based resin (ETFE, PVDF), styrene-based resins (monopolymer or copolymer containing styrene or styrene substitute), such as polystyrene, chloropolystyrene, poly-α-methylstyrene, styrene-butadiene copolymer, styrene-vinyl chloride copolymer, styrene-vinyl acetate copolymer, styrene-maleic acid copolymer, styrene-acrylic acid ester copolymer (such as styrene-methylacrylate copolymer, styrene-ethylacrylate copolymer, styrene-butylacrylate copolymer, styrene-octylacrylate copolymer and styrene-phenylacrylate copolymer), styrene-methacrylic acid ester copolymer (such as styrene-methylmethacrylate copolymer, styrene-ethylmethacrylate copolymer and styrene-phenylmethacrylate copolymer), styrene-α-chloromethylacrylate copolymer and styrene-acrylonitrile-acrylate copolymer, methylmethacrylate resin, butylmethacrylate resin, ethylacrylate resin, butylacrylate resin, modified acrylic resin (such as silicone-modified acrylic resin, vinyl chloride resin-modified acrylic resin and acryl-urethane resin), vinyl chloride resin, styrene-vinyl acetate copolymer, vinyl chloride-vinyl acetate copolymer, rosin-modified maleic acid resin, phenolic resin, epoxy resin, polyester resin, polyesterpolyurethane resin, polyethylene, polypropylene, polybutadiene, polyvinylidene chloride, ionomer resin, polyurethane resin, silicone resin, ketone resin, ethylene-ethylacrylate copolymer, xylene resin, polyvinyl butyral resin, polyamide resin, polyimide resin, modified polyphenylene oxide resin and modified polycarbonate. The resin material which constitutes the base layer is preferably polyimide resin. However, the present invention is not limited to these materials.

A resistance-value adjusting conductive agent may be added to the base layer 2. As the resistance-value adjusting conductive agent, the same materials as those resistance-value adjusting conductive agents to be added to the elastic layer 3 may be used.

Although not particularly limited as long as the objective of the present invention is achieved, the thickness of the base layer 2 is normally set in the range of from 50 to 200 μm, preferably, from 80 to 120 μm.

From the viewpoints of improving the rigidity and of ensuring the durability, the hardness of the base layer 2 is preferably set in the range of from 0.1 GPa to 2 GPa.

The hardness of the base layer is an average value of ten measured values obtained at ten arbitrary points of the base layer by means of a nano-indentation method using a NANO Indenter XP/DCM (made by MTS Systems Corporation/MTS NANO Instruments).

The volume resistivity of the base layer is preferably set in the range of from 10⁹ to 10¹³Ω·cm, more preferably, from 10¹⁰ to 10¹¹Ω·cm.

As the method for forming the elastic layer 3 and the base layer 2, for example, a centrifugal molding method in which a material is poured into a rotating cylinder-shaped mold to form a belt-shaped layer, a coating method in which a material is spray-coated or dip-coated so as to form a layer, or an injection method in which a material is injected into a gap between an inner mold and an outer mold to form a belt-shaped layer, may be used. Upon forming the elastic layer, curing and drying processes are carried out by heating, if necessary. Upon forming the base layer, a drying process is carried out by heating, if necessary.

In the case where an intermediate transfer belt having a structure shown in FIG. 1(A) is manufactured, the order of the formations of the elastic layer 3 and the base layer 2 is not particularly limited, and, for example, after preliminarily forming the elastic layer by the centrifugal molding method, the base layer may be formed by the centrifugal molding method or the coating method. For example, after preliminarily forming the base layer by the centrifugal molding method, the elastic layer may be formed by the centrifugal molding method or the coating method. For example, after preliminarily forming the elastic layer by the injection method, the base layer may be formed by the coating method. For example, after preliminarily forming the base layer by the injection method, the elastic layer may be formed by the coating method. The surface layer 4 may be formed, for example, by the above mentioned surface treatment of the surface of the elastic layer after the elastic layer 3 and the base layer 2 are formed.

In the case where an intermediate transfer belt having a structure shown in FIG. 1(B) is manufactured, the elastic layer 3 may be formed, for example, by the centrifugal molding method or the injection method. The surface layer 4 may be formed, for example, by the above mentioned surface treatment of the surface of the elastic layer after the elastic layer 3 is formed.

Image-Forming Apparatus

The intermediate transfer belt according to the present invention is used for an image-forming apparatus based upon an electrophotographic system, such as a copying machine, a facsimile and a laser printer, and when a toner image, formed on the surface of a photosensitive member, is transferred onto a recording material such as paper, the intermediate transfer belt is used for once supporting the toner image on its surface so as to be further transported. FIG. 3 shows one example of an image-forming apparatus in which the intermediate transfer belt of the present invention is used.

FIG. 3 is a schematic structural diagram showing a multi-color image-forming apparatus of a tandem-type that is one embodiment of an image-forming apparatus according to the present invention. In the present embodiment, the intermediate transfer belt of the present invention is represented by reference numeral “1”, and has an seamless shape. The intermediate transfer belt 1 is wound around a driving roller 110a, a tension roller 110b and a backup roller 110c as a supporting member. Four image-forming units are disposed in a directly-connected state along the horizontal portion of the intermediate transfer belt 1. These image-forming units have substantially the same structure, but differ from one another in that they respectively form toner images of different colors, that is, yellow (Y) color, magenta (M) color, cyan (C) color and black (K) color.

Firstly, the image-forming units will be described. Each of the image-forming units is provided with an electrophotographic photosensitive member (hereinafter, referred to as “photosensitive drum”) 103 that has a drum shape and serves as an image-supporting member placed so as to rotate. On the periphery of the photosensitive drum 103, processing devices, such as a primary charger 104 serving as a primary charging means, an exposing device 105 serving as an exposing means, a developing device 106 serving as a developing means, a transferring device 107 serving as a primary transferring means and a cleaning device 108 serving as a cleaning means, are installed. The other image-forming units also have the same structure. Specifically, each of the image-forming units has the photosensitive drum 103, the primary charger 104, the exposing device 105, the developing device 106, the transferring roller 107 and the cleaning device 108. The image-forming units differ from one another in that they respectively form toner images of respective yellow, magenta, cyan and black colors. A developing vessel (not shown) is normally placed around the developing device 106 disposed in each of the image-forming units, and the respective developing vessels house yellow toner (yellow developer), magenta toner (magenta developer), cyan toner (cyan developer) and black toner (black developer).

Next, the following description will discuss image-forming operations of the image-forming apparatus having the above-mentioned structure. The photosensitive drum 103 is uniformly charged by the primary charger 104, and an image signal derived from a yellow color component of a document sent from the exposing device (electrostatic latent-image forming means) 105 is applied onto the photosensitive drum 103 through a polygon mirror and the like so that an electrostatic latent-image is formed thereon. Next, yellow toner is supplied from the developer 106 so that the electrostatic latent-image is developed as a yellow toner image. This yellow toner image is allowed to reach the primary transferring unit where the photosensitive drum 103 and the intermediate transfer belt 1 are brought into contact with each other, in response to the rotation of the photosensitive drum. In the present example, the transferring roller 107 is disposed in the primary transferring unit as the primary transferring means, and a primary transferring bias voltage is applied thereto. Thus, the yellow toner image on the photosensitive drum 103 is primarily transferred onto the intermediate transfer belt 1. The intermediate transfer belt 1 supporting the yellow toner image is transported to the next image-forming unit. A magenta toner image, formed on the photosensitive drum in the image-forming unit by the same method as described above at this point of time, is transferred onto the yellow toner image in the primary transferring unit at which the transferring roller is placed. In the same manner, as the intermediate transfer belt proceeds in a direction indicated by an arrow, a cyan toner image and a black toner image are transferred and superposed on the above-mentioned toner image in the respective primary transferring units where the transferring rollers are placed in the same manner as described above. At this point of time, a recording material, sent from a paper-feeding cassette by paper-feeding roller and other transporting rollers, has reached the secondary transferring unit. In the secondary transferring unit, the secondary transferring device serving as the secondary transferring means, that is, a secondary transferring roller 110d (secondary transferring means) in the present example, is disposed face to face with the backup roller 110c in a manner so as to sandwich the intermediate transfer belt 1. A transferring bias voltage is applied to the secondary transferring roller 110d so that the above-mentioned toner images having four colors are transferred (secondarily transferred) onto the recording material S. The recording material on which the toner image has been transferred is transported to a fixing unit 111. In the fixing unit, the toner image is fixed on the recording material (the member to be secondarily transferred) S by applying heat and pressure thereto. Residual transfer toner on the photosensitive drum 103 that has not been transferred in the primary transferring unit is cleaned by the cleaning device 108. Residual transfer toner on the intermediate transfer belt 1 that has not been transferred in the secondary transferring unit is cleaned by an intermediate transferring member cleaning device 102 serving as an intermediate transferring member cleaning means, and is again supplied to the next image-forming process.

A specific example of the image-forming apparatus according to the present invention will be explained below by using FIG. 3. Each of the photosensitive drums 103 as an image-supporting member is formed by coating an outer circumferential face of a cylinder made of aluminum having a diameter of 30 mm with an organic photoconductive layer (OPC). Each of the photosensitive drums 103 is supported at both ends in a rotatable state by using flanges, and rotated and driven toward a clockwise direction in the Figure by transmitting a driving force from a driving motor (not shown in the Figure) to its one end. Each of the primary chargers 104 is a conductive roller having a roller shape. Each of the surfaces of the photosensitive drums 103 is uniformly charged to a negative polarity by contacting the conductive roller with the surface of the photosensitive drum 103 and applying a charging bias voltage to the conductive roller by means of a power source (not shown in the Figure). In present example, each of the exposing devices 105 consists of a LED array in which a polygon mirror (not shown in the Figure) is attached to its apex. A lighting of each of the exposing devices 105 is controlled by a driving circuit (not shown in the Figure) in response to an image signal. Each of the developers 106 comprises a toner container (not shown in the Figure) which contains each of negatively charged yellow, magenta, cyan and black toners, and a developing roller which is adjacent to a surface of the photosensitive drum 103. The developing roller is rotated by means of a driving unit (not shown in the Figure), and performs a development by applying a developing bias voltage from a developing bias power source (not shown in the Figure) to the developing roller. In the present specific example, the yellow, magenta, cyan and black toners are respectively contained in the above mentioned toner containers in the order mentioned from the upper stream side in a transporting direction of the recording material S. In the present specific example, the intermediate transfer belt 1 has a circumferential length of 1000 mm, and the velocity V is 250 mm per one second. Each of the transferring rollers 107 is arranged inside the intermediate transfer belt 1 in such a way that it is opposed to each of the photosensitive drums and contacted with the intermediate transfer belt. Each of the transferring rollers 107 is connected to a transferring bias power source (power source). A voltage having a positive polarity is applied to each of the transferring rollers 107. By means of an electrical field occurred due to the applied voltage, the color toner images having negative polarities formed on the photosensitive drums 103 are successively transferred to the intermediate transfer belt 1 which contacts with the photosensitive drums 103 so as to form a color image. The intermediate transfer belt 1 has a seamless shape in the present specific example.

### EXAMPLES

### Production of Intermediate Transfer Belt

### Experimental Example 1

Firstly, an elastic layer made of urethane rubber was formed by using a centrifugal molding method. More specifically, a mixed material consisting of 13 parts by weight of toluene, 10 parts by weight of polyurethane elastomer and 3 parts by weight of carbon black was poured into a rotating cylindrical mold, and heated to form a belt-shaped elastic layer. According to this process, the surface roughness on the inner circumferential face of the cylindrical mold was transferred as it is onto the surface of the elastic layer, and the elastic layer had the surface roughness, hardness and thickness shown in Table 1.

Next, a base layer made of polyimide was formed by using a centrifugal molding method. More specifically, a mixed material consisting of 450 parts by weight of N-methyl-2-pyrrolidone, 35 parts by weight of 4,4′-diaminodiphenylether, 50 parts by weight of 3,3′,4,4′-biphenyltetracarboxylic acid dianhydride and 20 parts by weight of carbon black was poured into the cylindrical mold on which the elastic layer was formed, and heated to form the base layer on the inner side of the elastic layer in order to obtain a precursor of belt. The base layer had a hardness of 1 GPa and a thickness of 100 μm.

Lastly, the elastic layer was subjected to a surface treatment. More specifically, a mold was fitted onto the inner circumferential surface of the base layer in the precursor of belt, and the obtained precursor of belt equipped with the mold was immersed in a surface-treating liquid (a solution of isocyanate compound) to modify the surface of the elastic layer in order to obtain a seamless intermediate transfer belt. Conditions for the surface treatment were shown in Table 1.

### Experimental Examples 2 to 265

Intermediate transfer belts were produced by using the same method as that described in Experimental Example 1, except that the following operations were performed.

(i) The Er/Ep ratios of the surface layers were controlled to the predetermined values by adjusting the kinds and the concentrations (blending ratios) of the isocyanate compounds as well as the immersing times.

(ii) The hardnesses of the elastic layers were controlled to the predetermined values by changing the forming component of the polyurethane elastomers.

(iii) The thicknesses of the elastic layers were controlled to the predetermined values by adjusting the amounts of the mixed materials to be poured into the mold.

(iv) The surface roughnesses of the elastic layers were controlled to the predetermined values by changing the surface roughnesses of the inner circumferential surfaces of the mold.

### Referential Example 1

A base layer made of polyimide was formed by using a centrifugal molding method. More specifically, a mixed material consisting of 450 parts by weight of N-methyl-2-pyrrolidone, 35 parts by weight of 4,4′-diaminodiphenylether, 50 parts by weight of 3,3′,4,4′-biphenyltetracarboxylic acid dianhydride and 20 parts by weight of carbon black was poured into a cylindrical mold, and heated in order to obtain a seamless intermediate transfer belt consisting of only the base layer. The base layer had a hardness of 1 GPa and a thickness of 100 μm.

### Referential Example 2

A seamless intermediate transfer belt was obtained by using the same method as that described in Experimental Example 1, except that the surface of the elastic layer was not subjected to the surface treatment.

### Referential Example 3

A seamless intermediate transfer belt was obtained by using the same method as that described in Experimental Example 1, except that a resin layer made of a fluororesin was formed instead of subjecting the surface of the elastic layer to the surface treatment. The resin layer had a thickness of 5 μm.

### Referential Example 4

Hundred parts by weight of nylon 12 (made by UBE INDUSTRIES, LTD.; UBESTA 3035 JU3) (which is a thermoplastic polyamide), 20 parts by weight of PA12 elastomer (made by Daicel-Degussa Ltd.; DIAMIDE, BESTAMIDE E68) (which is a thermoplastic elastomer) and 30 parts by weight of acetylene black were kneaded by using a twin-screw kneader to obtain pellets. The obtained pellets were extruded and molded by using an extrusion-molding machine to obtain a seamless intermediate transfer belt having a thickness of 100 μm.

Evaluation

Measurements

A compression-release hysteresis (Er/Ep ratio) and a hardness on the surface of each of the intermediate transfer belts were measured by the above mentioned methods.

Image-Loss

Each of the intermediate transfer belts produced as described above was installed in a bizhub 650 made by Konica Minolta Technologies, Inc., and printing operations were carried out by printing an evaluation chart with a line image having a width of 300 μm on regular papers. Unless otherwise specified, standard accessories and standard conditions of the above mentioned printer were used. After continuous printing operations of 50,000 sheets were carried out, each of the printed images was visually observed, and evaluated on image-loss phenomenon.

◯: No image-loss occurred.
x: An image-loss occurred.

Transferring Property to Concavities and Convexities

Transferring property to concavities and convexities was evaluated by using the same method as that adopted in the evaluation method for image-loss mentioned above, except that papers (Leathac Paper; 300 g/m²) having concavities and convexities were used and transferring property to concave portions was particularly evaluated.

◯: Transfers to the concavities and convexities were satisfactorily carried out.
x: There were printed places where transfers to the concavities and convexities were not effectively carried out.

Secondary Transferring Property

Secondary transfer rate was evaluated by using the same method as that adopted in the evaluation method for image-loss mentioned above, except that a solid image was printed and, after continuous printing operations of 50,000 sheets were carried out, a ratio of the weight of the toner image secondary transferred on a paper to that transferred on the intermediate transfer belt was measured.

◯: The secondary transfer rate was increased to a higher value than that in the case where the intermediate transfer belt produced in Referential Example 1 was used.
x: The secondary transfer rate was decreased to a lower value than that in the case where the intermediate transfer belt produced in Referential Example 1 was used.

TABLE 1

| | Elastic Layer Conditions | | | Surface | | | | | Quality | | |
|---|---|---|---|---|---|---|---|---|---|---|---|
| | | | Surface | Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 10 | 50 | 0.3 | CoronateHX | 30% | 40 | 15% | 30 | ∘ | x | ∘ |
| Example 1 | | | | | | | | | | | |
| Experimental | 10 | 100 | 0.3 | CoronateHX | 30% | 40 | 15% | 30 | ∘ | x | ∘ |
| Example 2 | | | | | | | | | | | |
| Experimental | 10 | 300 | 0.3 | CoronateHX | 30% | 40 | 15% | 30 | ∘ | x | ∘ |
| Example 3 | | | | | | | | | | | |
| Experimental | 10 | 500 | 0.3 | CoronateHX | 30% | 40 | 15% | 30 | ∘ | x | ∘ |
| Example 4 | | | | | | | | | | | |
| Experimental | 10 | 600 | 0.3 | CoronateHX | 30% | 40 | 15% | 30 | ∘ | x | ∘ |
| Example 5 | | | | | | | | | | | |
| Experimental | 10 | 50 | 0.3 | CoronateHX | 30% | 30 | 25% | 30 | ∘ | ∘ | ∘ |
| Example 6 | | | | | | | | | | | |
| Experimental | 10 | 100 | 0.3 | CoronateHX | 30% | 30 | 25% | 30 | ∘ | ∘ | ∘ |
| Example 7 | | | | | | | | | | | |
| Experimental | 10 | 300 | 0.3 | CoronateHX | 30% | 30 | 25% | 30 | ∘ | ∘ | ∘ |
| Example 8 | | | | | | | | | | | |
| Experimental | 10 | 500 | 0.3 | CoronateHX | 30% | 30 | 25% | 30 | ∘ | ∘ | ∘ |
| Example 9 | | | | | | | | | | | |
| Experimental | 10 | 600 | 0.3 | CoronateHX | 30% | 30 | 25% | 30 | ∘ | ∘ | ∘ |
| Example 10 | | | | | | | | | | | |
| Experimental | 10 | 50 | 0.3 | CoronateHX | 30% | 20 | 50% | 30 | ∘ | ∘ | ∘ |
| Example 11 | | | | | | | | | | | |
| Experimental | 10 | 100 | 0.3 | CoronateHX | 30% | 20 | 50% | 30 | ∘ | ∘ | ∘ |
| Example 12 | | | | | | | | | | | |
| Experimental | 10 | 300 | 0.3 | CoronateHX | 30% | 20 | 50% | 30 | ∘ | ∘ | ∘ |
| Example 13 | | | | | | | | | | | |
| Experimental | 10 | 500 | 0.3 | CoronateHX | 30% | 20 | 50% | 30 | ∘ | ∘ | ∘ |
| Example 14 | | | | | | | | | | | |
| Experimental | 10 | 600 | 0.3 | CoronateHX | 30% | 20 | 50% | 30 | ∘ | ∘ | ∘ |
| Example 15 | | | | | | | | | | | |
| Experimental | 10 | 50 | 0.3 | CoronateHX | 30% | 10 | 75% | 30 | ∘ | ∘ | ∘ |
| Example 16 | | | | | | | | | | | |
| Experimental | 10 | 100 | 0.3 | CoronateHX | 30% | 10 | 75% | 30 | ∘ | ∘ | ∘ |
| Example 17 | | | | | | | | | | | |
| Experimental | 10 | 300 | 0.3 | CoronateHX | 30% | 10 | 75% | 30 | ∘ | ∘ | ∘ |
| Example 18 | | | | | | | | | | | |
| Experimental | 10 | 500 | 0.3 | CoronateHX | 30% | 10 | 75% | 30 | ∘ | ∘ | ∘ |
| Example 19 | | | | | | | | | | | |
| Experimental | 10 | 600 | 0.3 | CoronateHX | 30% | 10 | 75% | 30 | ∘ | ∘ | ∘ |
| Example 20 | | | | | | | | | | | |
| Experimental | 10 | 50 | 0.3 | CoronateHX | 30% | 8 | 90% | 30 | ∘ | x | x |
| Example 21 | | | | | | | | | | | |
| Experimental | 10 | 100 | 0.3 | CoronateHX | 30% | 8 | 90% | 30 | ∘ | x | x |
| Example 22 | | | | | | | | | | | |
| Experimental | 10 | 300 | 0.3 | CoronateHX | 30% | 8 | 90% | 30 | ∘ | x | x |
| Example 23 | | | | | | | | | | | |
| Experimental | 10 | 500 | 0.3 | CoronateHX | 30% | 8 | 90% | 30 | ∘ | x | x |
| Example 24 | | | | | | | | | | | |
| Experimental | 10 | 600 | 0.3 | CoronateHX | 30% | 8 | 90% | 30 | ∘ | x | x |
| Example 25 | | | | | | | | | | | |

TABLE 2

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 20 | 50 | 0.3 | CoronateHX | 30% | 40 | 15% | 35 | ∘ | x | ∘ |
| Example 26 | | | | | | | | | | | |
| Experimental | 20 | 100 | 0.3 | CoronateHX | 30% | 40 | 15% | 35 | ∘ | x | ∘ |
| Example 27 | | | | | | | | | | | |
| Experimental | 20 | 300 | 0.3 | CoronateHX | 30% | 40 | 15% | 35 | ∘ | x | ∘ |
| Example 28 | | | | | | | | | | | |
| Experimental | 20 | 500 | 0.3 | CoronateHX | 30% | 40 | 15% | 35 | ∘ | x | ∘ |
| Example 29 | | | | | | | | | | | |
| Experimental | 20 | 600 | 0.3 | CoronateHX | 30% | 40 | 15% | 35 | ∘ | x | ∘ |
| Example 30 | | | | | | | | | | | |
| Experimental | 20 | 50 | 0.3 | CoronateHX | 30% | 30 | 25% | 35 | ∘ | ∘ | ∘ |
| Example 31 | | | | | | | | | | | |
| Experimental | 20 | 100 | 0.3 | CoronateHX | 30% | 30 | 25% | 35 | ∘ | ∘ | ∘ |
| Example 32 | | | | | | | | | | | |
| Experimental | 20 | 300 | 0.3 | CoronateHX | 30% | 30 | 25% | 35 | ∘ | ∘ | ∘ |
| Example 33 | | | | | | | | | | | |
| Experimental | 20 | 500 | 0.3 | CoronateHX | 30% | 30 | 25% | 35 | ∘ | ∘ | ∘ |
| Example 34 | | | | | | | | | | | |
| Experimental | 20 | 600 | 0.3 | CoronateHX | 30% | 30 | 25% | 35 | ∘ | ∘ | ∘ |
| Example 35 | | | | | | | | | | | |
| Experimental | 20 | 50 | 0.3 | CoronateHX | 30% | 20 | 50% | 35 | ∘ | ∘ | ∘ |
| Example 36 | | | | | | | | | | | |
| Experimental | 20 | 100 | 0.3 | CoronateHX | 30% | 20 | 50% | 35 | ∘ | ∘ | ∘ |
| Example 37 | | | | | | | | | | | |
| Experimental | 20 | 300 | 0.3 | CoronateHX | 30% | 20 | 50% | 35 | ∘ | ∘ | ∘ |
| Example 38 | | | | | | | | | | | |
| Experimental | 20 | 500 | 0.3 | CoronateHX | 30% | 20 | 50% | 35 | ∘ | ∘ | ∘ |
| Example 39 | | | | | | | | | | | |
| Experimental | 20 | 600 | 0.3 | CoronateHX | 30% | 20 | 50% | 35 | ∘ | ∘ | ∘ |
| Example 40 | | | | | | | | | | | |
| Experimental | 20 | 50 | 0.3 | CoronateHX | 30% | 10 | 75% | 35 | ∘ | ∘ | ∘ |
| Example 41 | | | | | | | | | | | |
| Experimental | 20 | 100 | 0.3 | CoronateHX | 30% | 10 | 75% | 35 | ∘ | ∘ | ∘ |
| Example 42 | | | | | | | | | | | |
| Experimental | 20 | 300 | 0.3 | CoronateHX | 30% | 10 | 75% | 35 | ∘ | ∘ | ∘ |
| Example 43 | | | | | | | | | | | |
| Experimental | 20 | 500 | 0.3 | CoronateHX | 30% | 10 | 75% | 35 | ∘ | ∘ | ∘ |
| Example 44 | | | | | | | | | | | |
| Experimental | 20 | 600 | 0.3 | CoronateHX | 30% | 10 | 75% | 35 | ∘ | ∘ | ∘ |
| Example 45 | | | | | | | | | | | |
| Experimental | 20 | 50 | 0.3 | CoronateHX | 30% | 8 | 90% | 35 | ∘ | x | x |
| Example 46 | | | | | | | | | | | |
| Experimental | 20 | 100 | 0.3 | CoronateHX | 30% | 8 | 90% | 35 | ∘ | x | x |
| Example 47 | | | | | | | | | | | |
| Experimental | 20 | 300 | 0.3 | CoronateHX | 30% | 8 | 90% | 35 | ∘ | x | x |
| Example 48 | | | | | | | | | | | |
| Experimental | 20 | 500 | 0.3 | CoronateHX | 30% | 8 | 90% | 35 | ∘ | x | x |
| Example 49 | | | | | | | | | | | |
| Experimental | 20 | 600 | 0.3 | CoronateHX | 30% | 8 | 90% | 35 | ∘ | x | x |
| Example 50 | | | | | | | | | | | |

TABLE 3

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 30 | 50 | 0.3 | CoronateHX | 5% | 100 | 10% | 35 | ∘ | x | ∘ |
| Example 51 | | | | | | | | | | | |
| Experimental | 30 | 100 | 0.3 | CoronateHX | 5% | 100 | 10% | 35 | ∘ | x | ∘ |
| Example 52 | | | | | | | | | | | |
| Experimental | 30 | 300 | 0.3 | CoronateHX | 5% | 100 | 10% | 35 | ∘ | x | ∘ |
| Example 53 | | | | | | | | | | | |
| Experimental | 30 | 500 | 0.3 | CoronateHX | 5% | 100 | 10% | 35 | ∘ | x | ∘ |
| Example 54 | | | | | | | | | | | |
| Experimental | 30 | 600 | 0.3 | CoronateHX | 5% | 100 | 10% | 35 | ∘ | x | ∘ |
| Example 55 | | | | | | | | | | | |
| Experimental | 30 | 50 | 0.3 | CoronateHX | 30% | 40 | 15% | 40 | ∘ | x | ∘ |
| Example 56 | | | | | | | | | | | |
| Experimental | 30 | 100 | 0.3 | CoronateHX | 30% | 40 | 15% | 40 | ∘ | x | ∘ |
| Example 57 | | | | | | | | | | | |
| Experimental | 30 | 300 | 0.3 | CoronateHX | 30% | 40 | 15% | 40 | ∘ | x | ∘ |
| Example 58 | | | | | | | | | | | |
| Experimental | 30 | 500 | 0.3 | CoronateHX | 30% | 40 | 15% | 40 | ∘ | x | ∘ |
| Example 59 | | | | | | | | | | | |
| Experimental | 30 | 600 | 0.3 | CoronateHX | 30% | 40 | 15% | 40 | ∘ | x | ∘ |
| Example 60 | | | | | | | | | | | |
| Experimental | 30 | 50 | 0.3 | CoronateHX | 30% | 30 | 25% | 40 | ∘ | ∘ | ∘ |
| Example 61 | | | | | | | | | | | |
| Experimental | 30 | 100 | 0.3 | CoronateHX | 30% | 30 | 25% | 40 | ∘ | ∘ | ∘ |
| Example 62 | | | | | | | | | | | |
| Experimental | 30 | 300 | 0.3 | CoronateHX | 30% | 30 | 25% | 40 | ∘ | ∘ | ∘ |
| Example 63 | | | | | | | | | | | |
| Experimental | 30 | 500 | 0.3 | CoronateHX | 30% | 30 | 25% | 40 | ∘ | ∘ | ∘ |
| Example 64 | | | | | | | | | | | |
| Experimental | 30 | 600 | 0.3 | CoronateHX | 30% | 30 | 25% | 40 | ∘ | ∘ | ∘ |
| Example 65 | | | | | | | | | | | |
| Experimental | 30 | 50 | 0.3 | CoronateHX | 30% | 20 | 50% | 40 | ∘ | ∘ | ∘ |
| Example 66 | | | | | | | | | | | |
| Experimental | 30 | 100 | 0.3 | CoronateHX | 30% | 20 | 50% | 40 | ∘ | ∘ | ∘ |
| Example 67 | | | | | | | | | | | |
| Experimental | 30 | 300 | 0.3 | CoronateHX | 30% | 20 | 50% | 40 | ∘ | ∘ | ∘ |
| Example 68 | | | | | | | | | | | |
| Experimental | 30 | 500 | 0.3 | CoronateHX | 30% | 20 | 50% | 40 | ∘ | ∘ | ∘ |
| Example 69 | | | | | | | | | | | |
| Experimental | 30 | 600 | 0.3 | CoronateHX | 30% | 20 | 50% | 40 | ∘ | ∘ | ∘ |
| Example 70 | | | | | | | | | | | |
| Experimental | 30 | 50 | 0.3 | CoronateHX | 30% | 10 | 75% | 40 | ∘ | ∘ | ∘ |
| Example 71 | | | | | | | | | | | |
| Experimental | 30 | 100 | 0.3 | CoronateHX | 30% | 10 | 75% | 40 | ∘ | ∘ | ∘ |
| Example 72 | | | | | | | | | | | |
| Experimental | 30 | 300 | 0.3 | CoronateHX | 30% | 10 | 75% | 40 | ∘ | ∘ | ∘ |
| Example 73 | | | | | | | | | | | |
| Experimental | 30 | 500 | 0.3 | CoronateHX | 30% | 10 | 75% | 40 | ∘ | ∘ | ∘ |
| Example 74 | | | | | | | | | | | |
| Experimental | 30 | 600 | 0.3 | CoronateHX | 30% | 10 | 75% | 40 | ∘ | ∘ | ∘ |
| Example 75 | | | | | | | | | | | |
| Experimental | 30 | 50 | 0.3 | CoronateHX | 30% | 8 | 90% | 40 | ∘ | x | x |
| Example 76 | | | | | | | | | | | |
| Experimental | 30 | 100 | 0.3 | CoronateHX | 30% | 8 | 90% | 40 | ∘ | x | x |
| Example 77 | | | | | | | | | | | |
| Experimental | 30 | 300 | 0.3 | CoronateHX | 30% | 8 | 90% | 40 | ∘ | x | x |
| Example 78 | | | | | | | | | | | |
| Experimental | 30 | 500 | 0.3 | CoronateHX | 30% | 8 | 90% | 40 | ∘ | x | x |
| Example 79 | | | | | | | | | | | |
| Experimental | 30 | 600 | 0.3 | CoronateHX | 30% | 8 | 90% | 40 | ∘ | x | x |
| Example 80 | | | | | | | | | | | |

TABLE 4

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 40 | 50 | 0.3 | CoronateHX | 30% | 40 | 15% | 45 | ∘ | x | ∘ |
| Example 81 | | | | | | | | | | | |
| Experimental | 40 | 100 | 0.3 | CoronateHX | 30% | 40 | 15% | 45 | ∘ | x | ∘ |
| Example 82 | | | | | | | | | | | |
| Experimental | 40 | 300 | 0.3 | CoronateHX | 30% | 40 | 15% | 45 | ∘ | x | ∘ |
| Example 83 | | | | | | | | | | | |
| Experimental | 40 | 500 | 0.3 | CoronateHX | 30% | 40 | 15% | 45 | ∘ | x | ∘ |
| Example 84 | | | | | | | | | | | |
| Experimental | 40 | 600 | 0.3 | CoronateHX | 30% | 40 | 15% | 45 | ∘ | x | ∘ |
| Example 85 | | | | | | | | | | | |
| Experimental | 40 | 50 | 0.3 | CoronateHX | 30% | 30 | 25% | 45 | ∘ | ∘ | ∘ |
| Example 86 | | | | | | | | | | | |
| Experimental | 40 | 100 | 0.3 | CoronateHX | 30% | 30 | 25% | 45 | ∘ | ∘ | ∘ |
| Example 87 | | | | | | | | | | | |
| Experimental | 40 | 300 | 0.3 | CoronateHX | 30% | 30 | 25% | 45 | ∘ | ∘ | ∘ |
| Example 88 | | | | | | | | | | | |
| Experimental | 40 | 500 | 0.3 | CoronateHX | 30% | 30 | 25% | 45 | ∘ | ∘ | ∘ |
| Example 89 | | | | | | | | | | | |
| Experimental | 40 | 600 | 0.3 | CoronateHX | 30% | 30 | 25% | 45 | ∘ | ∘ | ∘ |
| Example 90 | | | | | | | | | | | |
| Experimental | 40 | 50 | 0.3 | CoronateHX | 30% | 20 | 50% | 45 | ∘ | ∘ | ∘ |
| Example 91 | | | | | | | | | | | |
| Experimental | 40 | 100 | 0.3 | CoronateHX | 30% | 20 | 50% | 45 | ∘ | ∘ | ∘ |
| Example 92 | | | | | | | | | | | |
| Experimental | 40 | 300 | 0.3 | CoronateHX | 30% | 20 | 50% | 45 | ∘ | ∘ | ∘ |
| Example 93 | | | | | | | | | | | |
| Experimental | 40 | 500 | 0.3 | CoronateHX | 30% | 20 | 50% | 45 | ∘ | ∘ | ∘ |
| Example 94 | | | | | | | | | | | |
| Experimental | 40 | 600 | 0.3 | CoronateHX | 30% | 20 | 50% | 45 | ∘ | ∘ | ∘ |
| Example 95 | | | | | | | | | | | |
| Experimental | 40 | 50 | 0.3 | CoronateHX | 30% | 10 | 75% | 45 | ∘ | ∘ | ∘ |
| Example 96 | | | | | | | | | | | |
| Experimental | 40 | 100 | 0.3 | CoronateHX | 30% | 10 | 75% | 45 | ∘ | ∘ | ∘ |
| Example 97 | | | | | | | | | | | |
| Experimental | 40 | 300 | 0.3 | CoronateHX | 30% | 10 | 75% | 45 | ∘ | ∘ | ∘ |
| Example 98 | | | | | | | | | | | |
| Experimental | 40 | 500 | 0.3 | CoronateHX | 30% | 10 | 75% | 45 | ∘ | ∘ | ∘ |
| Example 99 | | | | | | | | | | | |
| Experimental | 40 | 600 | 0.3 | CoronateHX | 30% | 10 | 75% | 45 | ∘ | ∘ | ∘ |
| Example 100 | | | | | | | | | | | |
| Experimental | 40 | 50 | 0.3 | CoronateHX | 30% | 8 | 90% | 45 | ∘ | x | x |
| Example 101 | | | | | | | | | | | |
| Experimental | 40 | 100 | 0.3 | CoronateHX | 30% | 8 | 90% | 45 | ∘ | x | x |
| Example 102 | | | | | | | | | | | |
| Experimental | 40 | 300 | 0.3 | CoronateHX | 30% | 8 | 90% | 45 | ∘ | x | x |
| Example 103 | | | | | | | | | | | |
| Experimental | 40 | 500 | 0.3 | CoronateHX | 30% | 8 | 90% | 45 | ∘ | x | x |
| Example 104 | | | | | | | | | | | |
| Experimental | 40 | 600 | 0.3 | CoronateHX | 30% | 8 | 90% | 45 | ∘ | x | x |
| Example 105 | | | | | | | | | | | |

TABLE 5

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 50 | 50 | 0.3 | CoronateHX | 30% | 40 | 15% | 50 | ∘ | x | ∘ |
| Example 106 | | | | | | | | | | | |
| Experimental | 50 | 100 | 0.3 | CoronateHX | 30% | 40 | 15% | 50 | ∘ | x | ∘ |
| Example 107 | | | | | | | | | | | |
| Experimental | 50 | 300 | 0.3 | CoronateHX | 30% | 40 | 15% | 50 | ∘ | x | ∘ |
| Example 108 | | | | | | | | | | | |
| Experimental | 50 | 500 | 0.3 | CoronateHX | 30% | 40 | 15% | 50 | ∘ | x | ∘ |
| Example 109 | | | | | | | | | | | |
| Experimental | 50 | 600 | 0.3 | CoronateHX | 30% | 40 | 15% | 50 | ∘ | x | ∘ |
| Example 110 | | | | | | | | | | | |
| Experimental | 50 | 50 | 0.3 | CoronateHX | 30% | 30 | 25% | 50 | ∘ | ∘ | ∘ |
| Example 111 | | | | | | | | | | | |
| Experimental | 50 | 100 | 0.3 | CoronateHX | 30% | 30 | 25% | 50 | ∘ | ∘ | ∘ |
| Example 112 | | | | | | | | | | | |
| Experimental | 50 | 300 | 0.3 | CoronateHX | 30% | 30 | 25% | 50 | ∘ | ∘ | ∘ |
| Example 113 | | | | | | | | | | | |
| Experimental | 50 | 500 | 0.3 | CoronateHX | 30% | 30 | 25% | 50 | ∘ | ∘ | ∘ |
| Example 114 | | | | | | | | | | | |
| Experimental | 50 | 600 | 0.3 | CoronateHX | 30% | 30 | 25% | 50 | ∘ | ∘ | ∘ |
| Example 115 | | | | | | | | | | | |
| Experimental | 50 | 50 | 0.3 | CoronateHX | 30% | 20 | 50% | 50 | ∘ | ∘ | ∘ |
| Example 116 | | | | | | | | | | | |
| Experimental | 50 | 100 | 0.3 | CoronateHX | 30% | 20 | 50% | 50 | ∘ | ∘ | ∘ |
| Example 117 | | | | | | | | | | | |
| Experimental | 50 | 300 | 0.3 | CoronateHX | 30% | 20 | 50% | 50 | ∘ | ∘ | ∘ |
| Example 118 | | | | | | | | | | | |
| Experimental | 50 | 500 | 0.3 | CoronateHX | 30% | 20 | 50% | 50 | ∘ | ∘ | ∘ |
| Example 119 | | | | | | | | | | | |
| Experimental | 50 | 600 | 0.3 | CoronateHX | 30% | 20 | 50% | 50 | ∘ | ∘ | ∘ |
| Example 120 | | | | | | | | | | | |
| Experimental | 50 | 50 | 0.3 | CoronateHX | 30% | 10 | 75% | 50 | ∘ | ∘ | ∘ |
| Example 121 | | | | | | | | | | | |
| Experimental | 50 | 100 | 0.3 | CoronateHX | 30% | 10 | 75% | 50 | ∘ | ∘ | ∘ |
| Example 122 | | | | | | | | | | | |
| Experimental | 50 | 300 | 0.3 | CoronateHX | 30% | 10 | 75% | 50 | ∘ | ∘ | ∘ |
| Example 123 | | | | | | | | | | | |
| Experimental | 50 | 500 | 0.3 | CoronateHX | 30% | 10 | 75% | 50 | ∘ | ∘ | ∘ |
| Example 124 | | | | | | | | | | | |
| Experimental | 50 | 600 | 0.3 | CoronateHX | 30% | 10 | 75% | 50 | ∘ | ∘ | ∘ |
| Example 125 | | | | | | | | | | | |
| Experimental | 50 | 50 | 0.3 | CoronateHX | 30% | 8 | 90% | 50 | ∘ | x | x |
| Example 126 | | | | | | | | | | | |
| Experimental | 50 | 100 | 0.3 | CoronateHX | 30% | 8 | 90% | 50 | ∘ | x | x |
| Example 127 | | | | | | | | | | | |
| Experimental | 50 | 300 | 0.3 | CoronateHX | 30% | 8 | 90% | 50 | ∘ | x | x |
| Example 128 | | | | | | | | | | | |
| Experimental | 50 | 500 | 0.3 | CoronateHX | 30% | 8 | 90% | 50 | ∘ | x | x |
| Example 129 | | | | | | | | | | | |
| Experimental | 50 | 600 | 0.3 | CoronateHX | 30% | 8 | 90% | 50 | ∘ | x | x |
| Example 130 | | | | | | | | | | | |

TABLE 6

| | Elastic Layer Conditions | | | Surface | | | | | Quality | | |
|---|---|---|---|---|---|---|---|---|---|---|---|
| | | | Surface | Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 20 | 50 | 0.3 | CoronateHX | 20% | 5 | 5% | 15 | ∘ | x | x |
| Example 131 | | | | | | | | | | | |
| Experimental | 20 | 100 | 0.3 | CoronateHX | 20% | 5 | 5% | 15 | ∘ | x | x |
| Example 132 | | | | | | | | | | | |
| Experimental | 20 | 300 | 0.3 | CoronateHX | 20% | 5 | 5% | 15 | ∘ | x | x |
| Example 133 | | | | | | | | | | | |
| Experimental | 20 | 500 | 0.3 | CoronateHX | 20% | 5 | 5% | 15 | ∘ | x | x |
| Example 134 | | | | | | | | | | | |
| Experimental | 20 | 600 | 0.3 | CoronateHX | 20% | 5 | 5% | 15 | ∘ | x | x |
| Example 135 | | | | | | | | | | | |
| Experimental | 20 | 50 | 0.3 | CoronateHX | 20% | 60 | 15% | 35 | ∘ | x | ∘ |
| Example 136 | | | | | | | | | | | |
| Experimental | 20 | 100 | 0.3 | CoronateHX | 20% | 60 | 15% | 35 | ∘ | x | ∘ |
| Example 137 | | | | | | | | | | | |
| Experimental | 20 | 300 | 0.3 | CoronateHX | 20% | 60 | 15% | 35 | ∘ | x | ∘ |
| Example 138 | | | | | | | | | | | |
| Experimental | 20 | 500 | 0.3 | CoronateHX | 20% | 60 | 15% | 35 | ∘ | x | ∘ |
| Example 139 | | | | | | | | | | | |
| Experimental | 20 | 600 | 0.3 | CoronateHX | 20% | 60 | 15% | 35 | ∘ | x | ∘ |
| Example 140 | | | | | | | | | | | |
| Experimental | 20 | 50 | 0.3 | CoronateHX | 20% | 45 | 25% | 35 | ∘ | ∘ | ∘ |
| Example 141 | | | | | | | | | | | |
| Experimental | 20 | 100 | 0.3 | CoronateHX | 20% | 45 | 25% | 35 | ∘ | ∘ | ∘ |
| Example 142 | | | | | | | | | | | |
| Experimental | 20 | 300 | 0.3 | CoronateHX | 20% | 45 | 25% | 35 | ∘ | ∘ | ∘ |
| Example 143 | | | | | | | | | | | |
| Experimental | 20 | 500 | 0.3 | CoronateHX | 20% | 45 | 25% | 35 | ∘ | ∘ | ∘ |
| Example 144 | | | | | | | | | | | |
| Experimental | 20 | 600 | 0.3 | CoronateHX | 20% | 45 | 25% | 35 | ∘ | ∘ | ∘ |
| Example 145 | | | | | | | | | | | |
| Experimental | 20 | 50 | 0.3 | CoronateHX | 20% | 30 | 50% | 35 | ∘ | ∘ | ∘ |
| Example 146 | | | | | | | | | | | |
| Experimental | 20 | 100 | 0.3 | CoronateHX | 20% | 30 | 50% | 35 | ∘ | ∘ | ∘ |
| Example 147 | | | | | | | | | | | |
| Experimental | 20 | 300 | 0.3 | CoronateHX | 20% | 30 | 50% | 35 | ∘ | ∘ | ∘ |
| Example 148 | | | | | | | | | | | |
| Experimental | 20 | 500 | 0.3 | CoronateHX | 20% | 30 | 50% | 35 | ∘ | ∘ | ∘ |
| Example 149 | | | | | | | | | | | |
| Experimental | 20 | 600 | 0.3 | CoronateHX | 20% | 30 | 50% | 35 | ∘ | ∘ | ∘ |
| Example 150 | | | | | | | | | | | |
| Experimental | 20 | 50 | 0.3 | CoronateHX | 20% | 15 | 75% | 35 | ∘ | ∘ | ∘ |
| Example 151 | | | | | | | | | | | |
| Experimental | 20 | 100 | 0.3 | CoronateHX | 20% | 15 | 75% | 35 | ∘ | ∘ | ∘ |
| Example 152 | | | | | | | | | | | |
| Experimental | 20 | 300 | 0.3 | CoronateHX | 20% | 15 | 75% | 35 | ∘ | ∘ | ∘ |
| Example 153 | | | | | | | | | | | |
| Experimental | 20 | 500 | 0.3 | CoronateHX | 20% | 15 | 75% | 35 | ∘ | ∘ | ∘ |
| Example 154 | | | | | | | | | | | |
| Experimental | 20 | 600 | 0.3 | CoronateHX | 20% | 15 | 75% | 35 | ∘ | ∘ | ∘ |
| Example 155 | | | | | | | | | | | |
| Experimental | 20 | 50 | 0.3 | CoronateHX | 20% | 2 | 90% | 35 | ∘ | x | x |
| Example 156 | | | | | | | | | | | |
| Experimental | 20 | 100 | 0.3 | CoronateHX | 20% | 2 | 90% | 35 | ∘ | x | x |
| Example 157 | | | | | | | | | | | |
| Experimental | 20 | 300 | 0.3 | CoronateHX | 20% | 2 | 90% | 35 | ∘ | x | x |
| Example 158 | | | | | | | | | | | |
| Experimental | 20 | 500 | 0.3 | CoronateHX | 20% | 2 | 90% | 35 | ∘ | x | x |
| Example 159 | | | | | | | | | | | |
| Experimental | 20 | 600 | 0.3 | CoronateHX | 20% | 2 | 90% | 35 | ∘ | x | x |
| Example 160 | | | | | | | | | | | |

TABLE 7

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 20 | 50 | 0.3 | CoronateHX | 40% | 30 | 15% | 35 | ∘ | x | ∘ |
| Example 161 | | | | | | | | | | | |
| Experimental | 20 | 100 | 0.3 | CoronateHX | 40% | 30 | 15% | 35 | ∘ | x | ∘ |
| Example 162 | | | | | | | | | | | |
| Experimental | 20 | 300 | 0.3 | CoronateHX | 40% | 30 | 15% | 35 | ∘ | x | ∘ |
| Example 163 | | | | | | | | | | | |
| Experimental | 20 | 500 | 0.3 | CoronateHX | 40% | 30 | 15% | 35 | ∘ | x | ∘ |
| Example 164 | | | | | | | | | | | |
| Experimental | 20 | 600 | 0.3 | CoronateHX | 40% | 30 | 15% | 35 | ∘ | x | ∘ |
| Example 165 | | | | | | | | | | | |
| Experimental | 20 | 50 | 0.3 | CoronateHX | 40% | 22 | 25% | 35 | ∘ | ∘ | ∘ |
| Example 166 | | | | | | | | | | | |
| Experimental | 20 | 100 | 0.3 | CoronateHX | 40% | 22 | 25% | 35 | ∘ | ∘ | ∘ |
| Example 167 | | | | | | | | | | | |
| Experimental | 20 | 300 | 0.3 | CoronateHX | 40% | 22 | 25% | 35 | ∘ | ∘ | ∘ |
| Example 168 | | | | | | | | | | | |
| Experimental | 20 | 500 | 0.3 | CoronateHX | 40% | 22 | 25% | 35 | ∘ | ∘ | ∘ |
| Example 169 | | | | | | | | | | | |
| Experimental | 20 | 600 | 0.3 | CoronateHX | 40% | 22 | 25% | 35 | ∘ | ∘ | ∘ |
| Example 170 | | | | | | | | | | | |
| Experimental | 20 | 50 | 0.3 | CoronateHX | 40% | 17 | 50% | 35 | ∘ | ∘ | ∘ |
| Example 171 | | | | | | | | | | | |
| Experimental | 20 | 100 | 0.3 | CoronateHX | 40% | 17 | 50% | 35 | ∘ | ∘ | ∘ |
| Example 172 | | | | | | | | | | | |
| Experimental | 20 | 300 | 0.3 | CoronateHX | 40% | 17 | 50% | 35 | ∘ | ∘ | ∘ |
| Example 173 | | | | | | | | | | | |
| Experimental | 20 | 500 | 0.3 | CoronateHX | 40% | 17 | 50% | 35 | ∘ | ∘ | ∘ |
| Example 174 | | | | | | | | | | | |
| Experimental | 20 | 600 | 0.3 | CoronateHX | 40% | 17 | 50% | 35 | ∘ | ∘ | ∘ |
| Example 175 | | | | | | | | | | | |
| Experimental | 20 | 50 | 0.3 | CoronateHX | 40% | 7 | 75% | 35 | ∘ | ∘ | ∘ |
| Example 176 | | | | | | | | | | | |
| Experimental | 20 | 100 | 0.3 | CoronateHX | 40% | 7 | 75% | 35 | ∘ | ∘ | ∘ |
| Example 177 | | | | | | | | | | | |
| Experimental | 20 | 300 | 0.3 | CoronateHX | 40% | 7 | 75% | 35 | ∘ | ∘ | ∘ |
| Example 178 | | | | | | | | | | | |
| Experimental | 20 | 500 | 0.3 | CoronateHX | 40% | 7 | 75% | 35 | ∘ | ∘ | ∘ |
| Example 179 | | | | | | | | | | | |
| Experimental | 20 | 600 | 0.3 | CoronateHX | 40% | 7 | 75% | 35 | ∘ | ∘ | ∘ |
| Example 180 | | | | | | | | | | | |
| Experimental | 20 | 50 | 0.3 | CoronateHX | 40% | 1 | 90% | 35 | ∘ | x | x |
| Example 181 | | | | | | | | | | | |
| Experimental | 20 | 100 | 0.3 | CoronateHX | 40% | 1 | 90% | 35 | ∘ | x | x |
| Example 182 | | | | | | | | | | | |
| Experimental | 20 | 300 | 0.3 | CoronateHX | 40% | 1 | 90% | 35 | ∘ | x | x |
| Example 183 | | | | | | | | | | | |
| Experimental | 20 | 500 | 0.3 | CoronateHX | 40% | 1 | 90% | 35 | ∘ | x | x |
| Example 184 | | | | | | | | | | | |
| Experimental | 20 | 600 | 0.3 | CoronateHX | 40% | 1 | 90% | 35 | ∘ | x | x |
| Example 185 | | | | | | | | | | | |

TABLE 8

| | Elastic Layer Conditions | | | Surface | | | | | Quality | | |
|---|---|---|---|---|---|---|---|---|---|---|---|
| | | | Surface | Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 40 | 50 | 0.3 | CoronateL | 30% | 60 | 15% | 45 | ∘ | x | ∘ |
| Example 186 | | | | | | | | | | | |
| Experimental | 40 | 100 | 0.3 | CoronateL | 30% | 60 | 15% | 45 | ∘ | x | ∘ |
| Example 187 | | | | | | | | | | | |
| Experimental | 40 | 300 | 0.3 | CoronateL | 30% | 60 | 15% | 45 | ∘ | x | ∘ |
| Example 188 | | | | | | | | | | | |
| Experimental | 40 | 500 | 0.3 | CoronateL | 30% | 60 | 15% | 45 | ∘ | x | ∘ |
| Example 189 | | | | | | | | | | | |
| Experimental | 40 | 600 | 0.3 | CoronateL | 30% | 60 | 15% | 45 | ∘ | x | ∘ |
| Example 190 | | | | | | | | | | | |
| Experimental | 40 | 50 | 0.3 | CoronateL | 30% | 45 | 25% | 45 | ∘ | ∘ | ∘ |
| Example 191 | | | | | | | | | | | |
| Experimental | 40 | 100 | 0.3 | CoronateL | 30% | 45 | 25% | 45 | ∘ | ∘ | ∘ |
| Example 192 | | | | | | | | | | | |
| Experimental | 40 | 300 | 0.3 | CoronateL | 30% | 45 | 25% | 45 | ∘ | ∘ | ∘ |
| Example 193 | | | | | | | | | | | |
| Experimental | 40 | 500 | 0.3 | CoronateL | 30% | 45 | 25% | 45 | ∘ | ∘ | ∘ |
| Example 194 | | | | | | | | | | | |
| Experimental | 40 | 600 | 0.3 | CoronateL | 30% | 45 | 25% | 45 | ∘ | ∘ | ∘ |
| Example 195 | | | | | | | | | | | |
| Experimental | 40 | 50 | 0.3 | CoronateL | 30% | 30 | 50% | 45 | ∘ | ∘ | ∘ |
| Example 196 | | | | | | | | | | | |
| Experimental | 40 | 100 | 0.3 | CoronateL | 30% | 30 | 50% | 45 | ∘ | ∘ | ∘ |
| Example 197 | | | | | | | | | | | |
| Experimental | 40 | 300 | 0.3 | CoronateL | 30% | 30 | 50% | 45 | ∘ | ∘ | ∘ |
| Example 198 | | | | | | | | | | | |
| Experimental | 40 | 500 | 0.3 | CoronateL | 30% | 30 | 50% | 45 | ∘ | ∘ | ∘ |
| Example 199 | | | | | | | | | | | |
| Experimental | 40 | 600 | 0.3 | CoronateL | 30% | 30 | 50% | 45 | ∘ | ∘ | ∘ |
| Example 200 | | | | | | | | | | | |
| Experimental | 40 | 50 | 0.3 | CoronateL | 30% | 15 | 75% | 45 | ∘ | ∘ | ∘ |
| Example 201 | | | | | | | | | | | |
| Experimental | 40 | 100 | 0.3 | CoronateL | 30% | 15 | 75% | 45 | ∘ | ∘ | ∘ |
| Example 202 | | | | | | | | | | | |
| Experimental | 40 | 300 | 0.3 | CoronateL | 30% | 15 | 75% | 45 | ∘ | ∘ | ∘ |
| Example 203 | | | | | | | | | | | |
| Experimental | 40 | 500 | 0.3 | CoronateL | 30% | 15 | 75% | 45 | ∘ | ∘ | ∘ |
| Example 204 | | | | | | | | | | | |
| Experimental | 40 | 600 | 0.3 | CoronateL | 30% | 15 | 75% | 45 | ∘ | ∘ | ∘ |
| Example 205 | | | | | | | | | | | |
| Experimental | 55 | 50 | 0.3 | CoronateL | 60% | 10 | 80% | 75 | ∘ | x | ∘ |
| Example 206 | | | | | | | | | | | |
| Experimental | 55 | 100 | 0.3 | CoronateL | 60% | 10 | 80% | 75 | ∘ | x | ∘ |
| Example 207 | | | | | | | | | | | |
| Experimental | 55 | 300 | 0.3 | CoronateL | 60% | 10 | 80% | 75 | ∘ | x | ∘ |
| Example 208 | | | | | | | | | | | |
| Experimental | 55 | 500 | 0.3 | CoronateL | 60% | 10 | 80% | 75 | ∘ | x | ∘ |
| Example 209 | | | | | | | | | | | |
| Experimental | 55 | 600 | 0.3 | CoronateL | 60% | 10 | 80% | 75 | ∘ | x | ∘ |
| Example 210 | | | | | | | | | | | |
| Experimental | 40 | 50 | 0.3 | CoronateL | 30% | 2 | 90% | 45 | ∘ | x | x |
| Example 211 | | | | | | | | | | | |
| Experimental | 40 | 100 | 0.3 | CoronateL | 30% | 2 | 90% | 45 | ∘ | x | x |
| Example 212 | | | | | | | | | | | |
| Experimental | 40 | 300 | 0.3 | CoronateL | 30% | 2 | 90% | 45 | ∘ | x | x |
| Example 213 | | | | | | | | | | | |
| Experimental | 40 | 500 | 0.3 | CoronateL | 30% | 2 | 90% | 45 | ∘ | x | x |
| Example 214 | | | | | | | | | | | |
| Experimental | 40 | 600 | 0.3 | CoronateL | 30% | 2 | 90% | 45 | ∘ | x | x |
| Example 215 | | | | | | | | | | | |

TABLE 9

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 40 | 50 | 0.3 | Coronate65 | 30% | 30 | 15% | 45 | ∘ | x | ∘ |
| Example 216 | | | | | | | | | | | |
| Experimental | 40 | 100 | 0.3 | Coronate65 | 30% | 30 | 15% | 45 | ∘ | x | ∘ |
| Example 217 | | | | | | | | | | | |
| Experimental | 40 | 300 | 0.3 | Coronate65 | 30% | 30 | 15% | 45 | ∘ | x | ∘ |
| Example 218 | | | | | | | | | | | |
| Experimental | 40 | 500 | 0.3 | Coronate65 | 30% | 30 | 15% | 45 | ∘ | x | ∘ |
| Example 219 | | | | | | | | | | | |
| Experimental | 40 | 600 | 0.3 | Coronate65 | 30% | 30 | 15% | 45 | ∘ | x | ∘ |
| Example 220 | | | | | | | | | | | |
| Experimental | 40 | 50 | 0.3 | Coronate65 | 30% | 22 | 25% | 45 | ∘ | ∘ | ∘ |
| Example 221 | | | | | | | | | | | |
| Experimental | 40 | 100 | 0.3 | Coronate65 | 30% | 22 | 25% | 45 | ∘ | ∘ | ∘ |
| Example 222 | | | | | | | | | | | |
| Experimental | 40 | 300 | 0.3 | Coronate65 | 30% | 22 | 25% | 45 | ∘ | ∘ | ∘ |
| Example 223 | | | | | | | | | | | |
| Experimental | 40 | 500 | 0.3 | Coronate65 | 30% | 22 | 25% | 45 | ∘ | ∘ | ∘ |
| Example 224 | | | | | | | | | | | |
| Experimental | 40 | 600 | 0.3 | Coronate65 | 30% | 22 | 25% | 45 | ∘ | ∘ | ∘ |
| Example 225 | | | | | | | | | | | |
| Experimental | 40 | 50 | 0.3 | Coronate65 | 30% | 17 | 50% | 45 | ∘ | ∘ | ∘ |
| Example 226 | | | | | | | | | | | |
| Experimental | 40 | 100 | 0.3 | Coronate65 | 30% | 17 | 50% | 45 | ∘ | ∘ | ∘ |
| Example 227 | | | | | | | | | | | |
| Experimental | 40 | 300 | 0.3 | Coronate65 | 30% | 17 | 50% | 45 | ∘ | ∘ | ∘ |
| Example 228 | | | | | | | | | | | |
| Experimental | 40 | 500 | 0.3 | Coronate65 | 30% | 17 | 50% | 45 | ∘ | ∘ | ∘ |
| Example 229 | | | | | | | | | | | |
| Experimental | 40 | 600 | 0.3 | Coronate65 | 30% | 17 | 50% | 45 | ∘ | ∘ | ∘ |
| Example 230 | | | | | | | | | | | |
| Experimental | 40 | 50 | 0.3 | Coronate65 | 30% | 14 | 75% | 45 | ∘ | ∘ | ∘ |
| Example 231 | | | | | | | | | | | |
| Experimental | 40 | 100 | 0.3 | Coronate65 | 30% | 14 | 75% | 45 | ∘ | ∘ | ∘ |
| Example 232 | | | | | | | | | | | |
| Experimental | 40 | 300 | 0.3 | Coronate65 | 30% | 14 | 75% | 45 | ∘ | ∘ | ∘ |
| Example 233 | | | | | | | | | | | |
| Experimental | 40 | 500 | 0.3 | Coronate65 | 30% | 14 | 75% | 45 | ∘ | ∘ | ∘ |
| Example 234 | | | | | | | | | | | |
| Experimental | 40 | 600 | 0.3 | Coronate65 | 30% | 14 | 75% | 45 | ∘ | ∘ | ∘ |
| Example 235 | | | | | | | | | | | |
| Experimental | 40 | 50 | 0.3 | Coronate65 | 30% | 12 | 90% | 45 | ∘ | x | x |
| Example 236 | | | | | | | | | | | |
| Experimental | 40 | 100 | 0.3 | Coronate65 | 30% | 12 | 90% | 45 | ∘ | x | x |
| Example 237 | | | | | | | | | | | |
| Experimental | 40 | 300 | 0.3 | Coronate65 | 30% | 12 | 90% | 45 | ∘ | x | x |
| Example 238 | | | | | | | | | | | |
| Experimental | 40 | 500 | 0.3 | Coronate65 | 30% | 12 | 90% | 45 | ∘ | x | x |
| Example 239 | | | | | | | | | | | |
| Experimental | 40 | 600 | 0.3 | Coronate65 | 30% | 12 | 90% | 45 | ∘ | x | x |
| Example 240 | | | | | | | | | | | |

TABLE 10

| | Elastic Layer Conditions | | | | | | | | Quality | | |
|---|---|---|---|---|---|---|---|---|---|---|---|
| | | | Surface | Surface Treatment Conditions | | | Surface Layer | | | Transferring Property | Secondary- |
| | JIS-A | Thickness | Roughness | | Blending | Time | | JIS-A | Image- | to Concavities and | Transferring |
| | Hardness | [μm] | [μm] | Kind | Ratio | [s] | Er/Ep | Hardness | Loss | Convexities | Property |
| Experimental | 20 | 50 | 0.9 | CoronateHX | 30% | 40 | 15% | 35 | ∘ | x | ∘ |
| Example 241 | | | | | | | | | | | |
| Experimental | 20 | 100 | 0.9 | CoronateHX | 30% | 40 | 15% | 35 | ∘ | x | ∘ |
| Example 242 | | | | | | | | | | | |
| Experimental | 20 | 300 | 0.9 | CoronateHX | 30% | 40 | 15% | 35 | ∘ | x | ∘ |
| Example 243 | | | | | | | | | | | |
| Experimental | 20 | 500 | 0.9 | CoronateHX | 30% | 40 | 15% | 35 | ∘ | x | ∘ |
| Example 244 | | | | | | | | | | | |
| Experimental | 20 | 600 | 0.9 | CoronateHX | 30% | 40 | 15% | 35 | ∘ | x | ∘ |
| Example 245 | | | | | | | | | | | |
| Experimental | 20 | 50 | 0.9 | CoronateHX | 30% | 30 | 25% | 35 | ∘ | ∘ | ∘ |
| Example 246 | | | | | | | | | | | |
| Experimental | 20 | 100 | 0.9 | CoronateHX | 30% | 30 | 25% | 35 | ∘ | ∘ | ∘ |
| Example 247 | | | | | | | | | | | |
| Experimental | 20 | 300 | 0.9 | CoronateHX | 30% | 30 | 25% | 35 | ∘ | ∘ | ∘ |
| Example 248 | | | | | | | | | | | |
| Experimental | 20 | 500 | 0.9 | CoronateHX | 30% | 30 | 25% | 35 | ∘ | ∘ | ∘ |
| Example 249 | | | | | | | | | | | |
| Experimental | 20 | 600 | 0.9 | CoronateHX | 30% | 30 | 25% | 35 | ∘ | ∘ | ∘ |
| Example 250 | | | | | | | | | | | |
| Experimental | 20 | 50 | 0.9 | CoronateHX | 30% | 20 | 50% | 35 | ∘ | ∘ | ∘ |
| Example 251 | | | | | | | | | | | |
| Experimental | 20 | 100 | 0.9 | CoronateHX | 30% | 20 | 50% | 35 | ∘ | ∘ | ∘ |
| Example 252 | | | | | | | | | | | |
| Experimental | 20 | 300 | 0.9 | CoronateHX | 30% | 20 | 50% | 35 | ∘ | ∘ | ∘ |
| Example 253 | | | | | | | | | | | |
| Experimental | 20 | 500 | 0.9 | CoronateHX | 30% | 20 | 50% | 35 | ∘ | ∘ | ∘ |
| Example 254 | | | | | | | | | | | |
| Experimental | 20 | 600 | 0.9 | CoronateHX | 30% | 20 | 50% | 35 | ∘ | ∘ | ∘ |
| Example 255 | | | | | | | | | | | |
| Experimental | 20 | 50 | 0.9 | CoronateHX | 30% | 10 | 75% | 35 | ∘ | ∘ | ∘ |
| Example 256 | | | | | | | | | | | |
| Experimental | 20 | 100 | 0.9 | CoronateHX | 30% | 10 | 75% | 35 | ∘ | ∘ | ∘ |
| Example 257 | | | | | | | | | | | |
| Experimental | 20 | 300 | 0.9 | CoronateHX | 30% | 10 | 75% | 35 | ∘ | ∘ | ∘ |
| Example 258 | | | | | | | | | | | |
| Experimental | 20 | 500 | 0.9 | CoronateHX | 30% | 10 | 75% | 35 | ∘ | ∘ | ∘ |
| Example 259 | | | | | | | | | | | |
| Experimental | 20 | 600 | 0.9 | CoronateHX | 30% | 10 | 75% | 35 | ∘ | ∘ | ∘ |
| Example 260 | | | | | | | | | | | |
| Experimental | 20 | 50 | 0.9 | CoronateHX | 30% | 8 | 90% | 35 | ∘ | x | x |
| Example 261 | | | | | | | | | | | |
| Experimental | 20 | 100 | 0.9 | CoronateHX | 30% | 8 | 90% | 35 | ∘ | x | x |
| Example 262 | | | | | | | | | | | |
| Experimental | 20 | 300 | 0.9 | CoronateHX | 30% | 8 | 90% | 35 | ∘ | x | x |
| Example 263 | | | | | | | | | | | |
| Experimental | 20 | 500 | 0.9 | CoronateHX | 30% | 8 | 90% | 35 | ∘ | x | x |
| Example 264 | | | | | | | | | | | |
| Experimental | 20 | 600 | 0.9 | CoronateHX | 30% | 8 | 90% | 35 | ∘ | x | x |
| Example 265 | | | | | | | | | | | |

TABLE 11

| | Elastic Layer Conditions | | | Surface | | | | | Quality | | |
|---|---|---|---|---|---|---|---|---|---|---|---|
| | | | Surface | Treatment Conditions | | | Surface Layer | | | Transferring Property | Secondary- |
| | JIS-A | Thickness | Roughness | | Blending | | | JIS-A | Image- | to Concavities and | Transferring |
| | Hardness | [μm] | [μm] | Kind | Ratio | Time [s] | Er/Ep | Hardness | Loss | Convexities | Property |
| Referential | — | — | — | — | — | — | 10 | — | ∘ | x | — |
| Example 1 | | | | | | | | | | | |
| Referential | 20 | 100 | 0.5 | — | — | — | 95 | 20 | ∘ | x | x |
| Example 2 | | | | | | | | | | | |
| Referential | 40 | 150 | 0.8 | — | — | — | 18 | 40 | ∘ | x | x |
| Example 3 | | | | | | | | | | | |
| Referential | 30 | 150 | 0I8 | — | — | — | 20 | 30 | ∘ | x | x |
| Example 4 | | | | | | | | | | | |

### EFFECTS OF THE INVENTION

The present invention makes it possible to sufficiently improve a transferring property to paper having concavities and convexities and to suppress a reduction of a secondary transfer rate.

What is claimed is:

1. An intermediate transfer member comprising an elastic layer and a surface layer formed on the elastic layer, said intermediate transfer member exhibiting 25 to 75% of Er/Ep ratio (wherein Ep is a product of a pushing displacement (μm) and a testing force (mN) at the time of compressing the surface layer by means of an indenter, and Er is a product of a pushing displacement (μm) and a testing force (mN) at the time of releasing the indenter from the surface layer).

2. The intermediate transfer member of claim 1, wherein the surface layer has a surface hardness of 30° to 65°.

3. The intermediate transfer member of claim 1, wherein the elastic layer has a thickness of 50 to 1000 μm.

4. The intermediate transfer member of claim 1, wherein the surface layer is formed by a surface treatment of a surface of the elastic layer with an isocyanate compound.

5. The intermediate transfer member of claim 1, wherein the surface layer has a thickness of 0.1 μm to 2.0 μm.

6. The intermediate transfer member of claim 1, wherein the surface layer has a surface roughness Rz of 0.05 μm to 1.5 μm.

7. An image-forming apparatus, comprising:
an intermediate transfer member comprising an elastic layer and a surface layer formed on the elastic layer, said intermediate transfer member exhibiting 25 to 75% of Er/Ep ratio (wherein Ep is a product of a pushing displacement (μm) and a testing force (mN) at the time of compressing the surface layer by means of an indenter, and Er is a product of a pushing displacement (μm) and a testing force (mN) at the time of releasing the indenter from the surface layer);
an image-forming unit for forming a toner image on the intermediate transfer member; and
an transferring unit for transferring the toner image formed on the intermediate transfer member onto a recording material.

8. The image-forming apparatus of claim 7, wherein the surface layer has a surface hardness of 30° to 65°.

9. The image-forming apparatus of claim 7, wherein the elastic layer has a thickness of 50 to 1000 μm.

10. The image-forming apparatus of claim 7, wherein the surface layer is formed by a surface treatment of a surface of the elastic layer with an isocyanate compound.

11. The image-forming apparatus of claim 7, wherein the surface layer has a thickness of 0.1 μm to 2.0 μm.

12. The image-forming apparatus of claim 7, wherein the surface layer has a surface roughness Rz of 0.05 μm to 1.5 μm.
